(19) United States
(12) Patent Application Publication
(10) Pub. No.: US 2015/0168906 A1
(43) Pub. Date: Jun. 18, 2015

(54) IMAGE FORMING SYSTEM, JAM CLEARING METHOD, AND STORAGE MEDIUM

(71) Applicant: CANON KABUSHIKI KAISHA, Tokyo (JP)

(72) Inventor: Yoko Ishii, Kawasaki-shi (JP)

(21) Appl. No.: 14/567,704

(22) Filed: Dec. 11, 2014

(30) Foreign Application Priority Data
Dec. 17, 2013 (JP) 2013-260410

(51) Int. Cl. G03G 15/00

(52) U.S. Cl. CPC G03G 15/70

(57) ABSTRACT

An image forming system includes sheet detection sensors to detect a jam of a sheet material, which are provided along a conveyance path for conveying the sheet material. The image forming system includes a printing apparatus, a large capacity stacker, a glue binding apparatus, and a saddle stitch binding apparatus, each having a cover. When being in an open state, each cover allows a user operation in the apparatus. Corresponding to each cover, an open/close detection sensor is provided to detect opening and closing of the corresponding cover. When a jam has been detected, the image forming system displays the apparatus including the sheet detection sensor that has detected the jam. When the open/close detection sensor corresponding to the cover of the apparatus detects the open state of the cover, the image forming system displays a moving image presenting a procedure for clearing the jam.

### BACKGROUND OF THE INVENTION

1. Field of the Invention

The present invention relates to a technique for improving operability in maintenance of an image forming system such as a printer and a multifunction peripheral.

2. Description of the Related Art

There is an image forming system that prompts a user to carry out handling, by displaying a maintenance handling procedure on a display, in maintenance such as handling for a paper jam (a jam) or toner supply. The handling procedure may be displayed using a moving image. Even complicated handling can be described in detail using a moving image. Therefore, even a user inexperienced in maintenance can carry out an appropriate operation.

Japanese Patent Application Laid-Open No. 2000-155508 discusses an image forming system that displays a handling procedure at occurrence of a jam by using a moving image. For example, this image forming system displays a jam occurrence location at occurrence of a jam, and sequentially displays a moving image for jam clearing according to a jam clearing procedure in response to a user operation.

The image forming system of Japanese Patent Application Laid-Open No. 2000-155508 first displays, upon occurrence of a jam, an instruction moving image for opening a cover at a jam occurrence location in the image forming system (hereinafter referred to as “an advance preparation moving image”). Next, in response to a user operation, an instruction moving image for the next process (hereinafter referred to as “a main moving image”) is displayed. There may be a case where the advance preparation moving image is unnecessary for a user who has experience in the operation to some extent. In this case, it is annoying for the user to switch from the advance preparation moving image to the main moving image. Moreover, when two or more jams occur, handling may be guided in a wrong procedure irrespective of procedural priorities, because the handling can proceed to the next step in response to an operation even if the previous operation is not completed. This may cause a failure in the image forming system. For example, in a case where a user experienced in the operation and a user inexperienced in the operation share an apparatus such as a print on demand (POD) apparatus, it is necessary to carry out handling in an appropriate procedure.

### SUMMARY OF THE INVENTION

The present invention is directed to an image forming system capable of allowing a user to perform appropriate maintenance.

According to an aspect of the present invention, an image forming system includes a plurality of sheet detection sensors provided along a conveyance path for a sheet material conveyed in a plurality of apparatuses, and configured to detect a jam of the sheet material, a plurality of covers provided in each of the plurality of apparatuses, and each configured to allow an operation by a user in the apparatus when being in an open state, a plurality of open/close detection sensors provided to correspond to each of the plurality of covers, and each configured to detect opening and closing of the corresponding cover, and a control unit configured to display, when the jam has been detected, occurrence of the jam together with the apparatus including the sheet detection sensor that has detected the jam, and to display, when the open/close detection sensor corresponding to the cover of the apparatus detects the open state of the cover, a moving image presenting a procedure for clearing the jam on a predetermined display.

Further features of the present invention will become apparent from the following description of exemplary embodiments with reference to the attached drawings.

### BRIEF DESCRIPTION OF THE DRAWINGS

FIG. 1 is a block diagram of a network system.

FIG. 2 is a block diagram of a control unit.

FIG. 3 is a block diagram of an operation unit.

FIG. 4 is an external view of the operation unit.

FIG. 5 is a diagram illustrating a configuration example of an image forming system.

FIG. 6 is an example diagram of a dialog box.

FIG. 7 is an example diagram of a moving image dialog box.

FIG. 8 is a flowchart illustrating a clearing procedure performed at occurrence of a jam.

FIG. 9 is a flowchart illustrating a clearing procedure performed at occurrence of a jam.

FIG. 10 is a flowchart illustrating a clearing procedure performed at occurrence of a jam.

### DESCRIPTION OF THE EMBODIMENTS

Various exemplary embodiments, features, and aspects of the invention will be described in detail below with reference to the drawings.

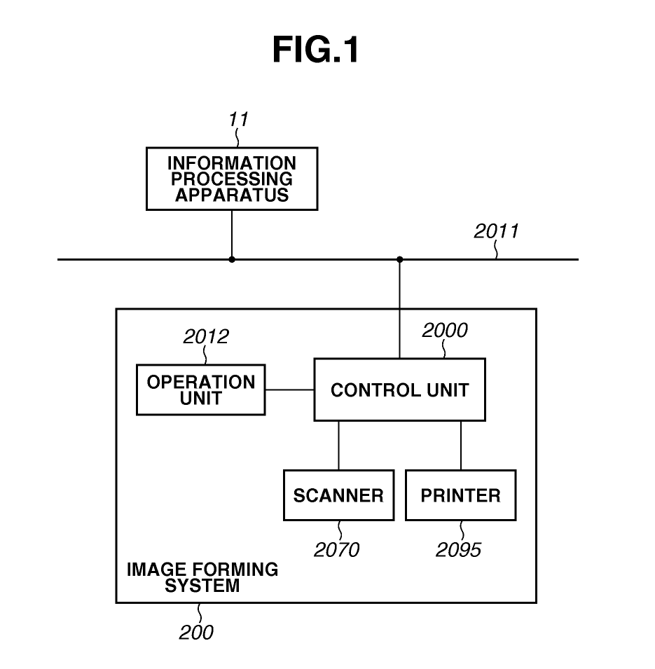

FIG. 1 is a block diagram of a network system including an image forming system according to a first exemplary embodiment. This network system includes an information processing apparatus 11 and an image forming system 200 capable of communicating with each other based on a predetermined protocol, via a network 2011 such as a local area network (LAN). The information processing apparatus 11 and the image forming system 200 may each be provided as more than one on the network 2011. The image forming system 200 is a print on demand (POD) apparatus, and can operate according to a request from the information processing apparatus 11.

The information processing apparatus 11 is a computer including a display device and an input device such as a keyboard or a pointing device. The information processing apparatus 11 performs various kinds of processing by reading various computer programs from a built-in mass storage device and executing the read programs. The information processing apparatus 11 obtains information by communicating with the image forming system 200 via the network 2011, and displays the obtained information on the display device. The information processing apparatus 11 further includes a web browser to perform communication with the image forming system 200 implementing a web server function to be described below.

The image forming system 200 includes a scanner 2070 that is an image input device, a printer 2095 that is an image output device, a control unit 2000, and an operation unit 2012 that is a user interface. The scanner 2070, the printer 2095, and the operation unit 2012 are connected to the control unit 2000, respectively. The control unit 2000 is connected to the network 2011. The operation unit 2012 includes, in addition to input buttons, a touch panel having a display and a touchpad.

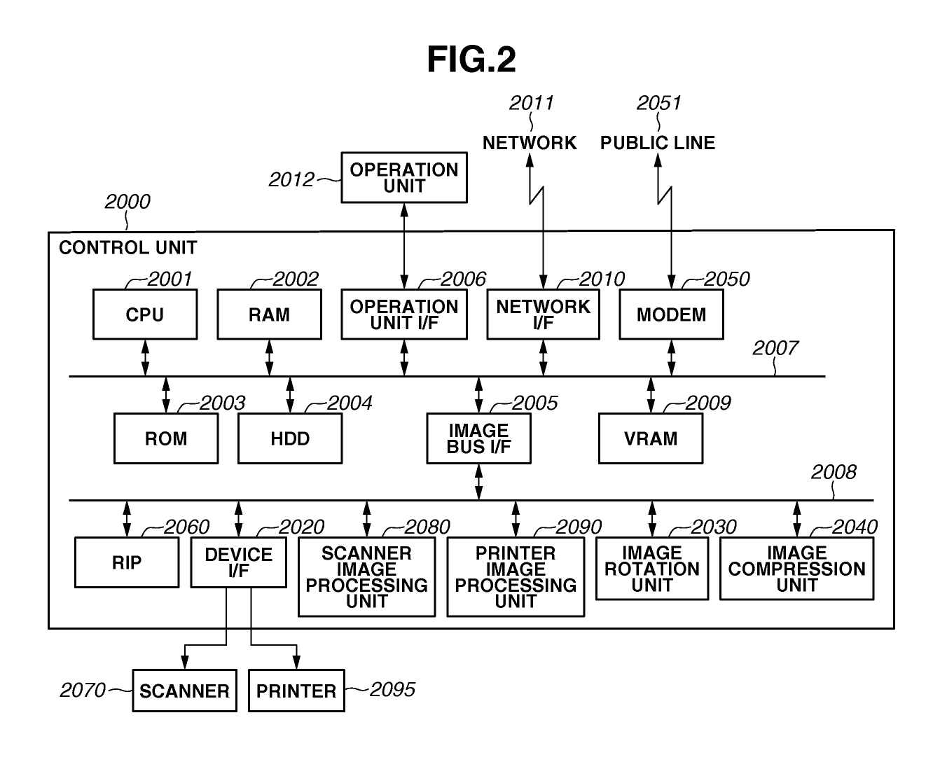

FIG. 2 is a block diagram of the control unit 2000 included in the image forming system 200.

A central processing unit (CPU) 2001 controls operations of the entire image forming system 200. A random access memory (RAM) 2002 is a work memory of the CPU 2001, and serves as an image memory that temporarily stores image data. A read only memory (ROM) 2003 serves as a boot ROM that stores a boot program of the image forming system 200. A hard disk drive (HDD) 2004 is a mass storage device that stores system software and image data.

An operation unit interface (I/F) 2006 performs interface control for the operation unit 2012. The operation unit I/F 2006 provides image data to be displayed on the display of the operation unit 2012. In addition, the operation unit I/F 2006 inputs into the CPU 2001 information entered by a user through an operation on the operation unit 2012.

A video random access memory (VRAM) 2009 holds image data generated in the CPU 2001. The CPU 2001 performs image processing on the image data obtained from the HDD 2004 based on the information input from the operation unit 2012, and causes the VRAM 2009 to hold such image data.

A network I/F 2010 is connected to the network 2011, and communicates with other devices via the network 2011. A modem 2050 is connected to a public line 2051, which is different from the network 2011, and communicates with other devices via the public line 2051.

The CPU 2001, the RAM 2002, the ROM 2003, the HDD 2004, the operation unit I/F 2006, the VRAM 2009, the network I/F 2010, and the modem 2050 are connected to a system bus 2007. The system bus 2007 is connected to an image bus 2008 by an image bus I/F 2005. The image bus I/F 2005 is a bus bridge that converts a data structure of data to be transferred from the system bus 2007 to the image bus 2008. The image bus 2008 is configured of a peripheral component interconnect (PCI) bus, or configured based on Institute of Electrical and Electronics Engineers (IEEE) 1394.

A raster image processor (RIP) 2060 develops the image data transferred from the system bus 2007 into a bitmapped image using a page description language (PDL) cord.

A device I/F 2020 performs interface control for the scanner 2070 and the printer 2095. The device I/F 2020 performs synchronous/asynchronous conversion of the image data between each of the scanner 2070 and the printer 2095 and the CPU 2001. A scanner image processing unit 2080 performs image processing such as correction, manipulation, and editing on the image data (input image data) input from the scanner 2070. A printer image processing unit 2090 performs image processing such as correction and resolution conversion on the image data (output image data) to be output to the printer 2095.

An image rotation unit 2030 performs rotation processing on image data. An image compression unit 2040 performs compression/decompression processing on image data. For example, the image compression unit 2040 performs compression/decompression using Joint Photographic Experts Group (JPEG) for multivalued image data, and using Joint Bi-level Image Experts Group (JBIG), Modified Modified READ (MMR), and Modified Huffman (MH) for binary image data.

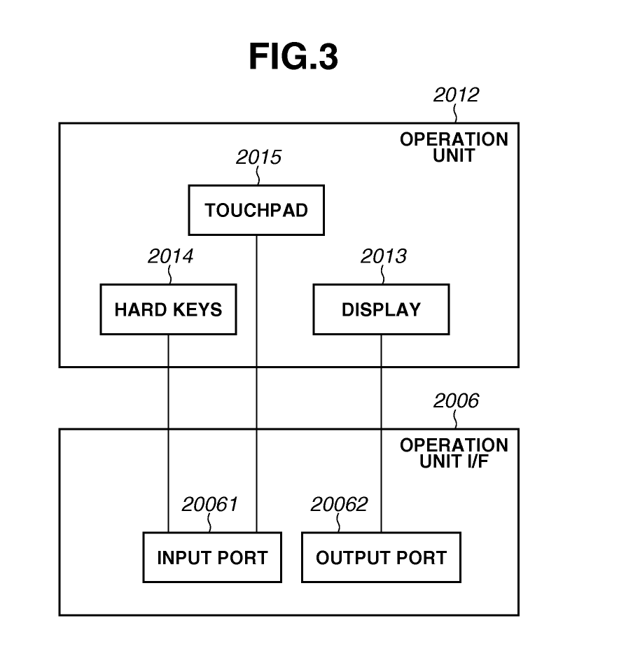

FIG. 3 is a block diagram of the operation unit 2012. The operation unit 2012 is connected to an input port 20061 and an output port 20062 included in the operation unit I/F 2006 of the control unit 2000.

The operation unit 2012 includes hard keys 2014 and the touch panel having a touchpad 2015 and a display 2013. The hard keys 2014 and the touchpad 2015 are connected to the input port 20061, and the display 2013 is connected to the output port 20062. Data entered through the hard keys 2014 and the touchpad 2015 is input into the control unit 2000 via the input port 20061. From the control unit 2000, the image data held in the VRAM 2009 is sent to the display 2013 via the output port 20062 to be displayed on the display 2013.

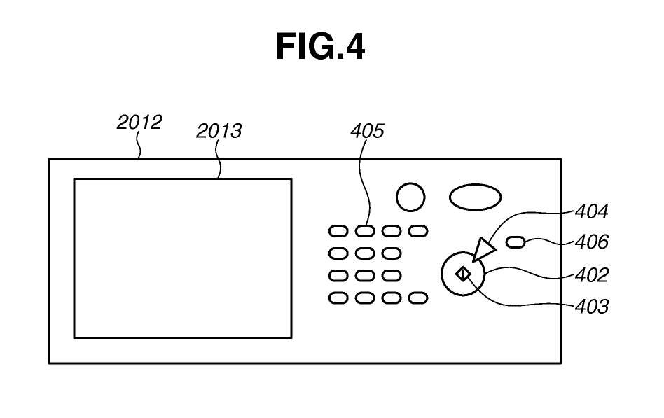

FIG. 4 is an external view of the operation unit 2012. The display 2013 is a liquid colored display (LCD). A touch panel sheet serving as the touchpad 2015 is affixed onto a display screen of the display 2013. Various screens and software keys can be displayed on the display 2013. The touch panel sheet transmits to the CPU 2001 the position of a point operated by a user on the display 2013.

A start key 402, a stop key 404, character/numeric keys 405, and a user mode key 406 are examples of the hard keys 2014. The start key 402 is used, for example, to instruct start of an operation for reading a document image. A light emitting diode (LED) 403 having two colors of green and red is placed in a central part of the start key 402. Using the colors, the LED 403 indicates whether the start key 402 can be used. The stop key 404 is provided to stop an operation in process. The character/numeric keys 405 are configured of number and character buttons, and provided to set the number of copies and to give an instruction for changing the screen of the display 2013. The user mode key 406 is provided to perform device settings.

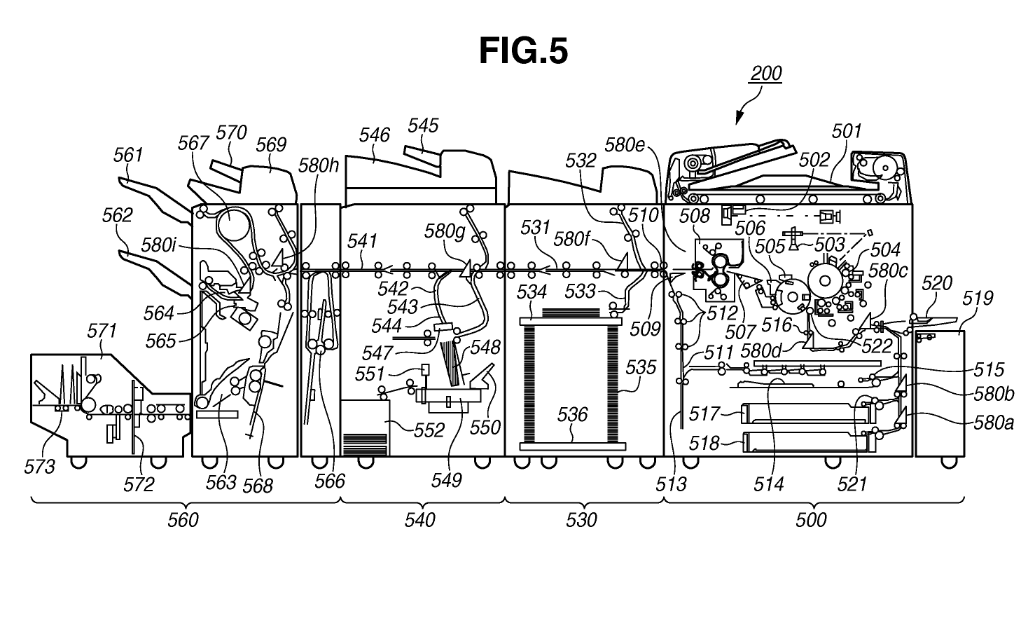

FIG. 5 is a diagram illustrating a configuration example of the image forming system 200. The image forming system 200 includes a plurality of sheet processing apparatuses such as a printing apparatus 500, a large capacity stacker 530, a glue binding apparatus 540, and a saddle stitch binding apparatus 560.

### <Printing Apparatus 500>

The printing apparatus 500 includes the scanner 2070 and the printer 2095. The printing apparatus 500 of the present exemplary embodiment is a color multifunction peripheral (MFP), but may be a monochrome MFP.

The scanner 2070 includes an auto document feeder (ADF) 501 and a reading unit 502. The ADF 501 conveys documents one by one onto a document table glass, from a bundle of documents (a document bundle) set in a document tray. The reading unit 502 generates image data by reading the document conveyed onto the document table glass.

The printer 2095 includes a rotating polygon mirror 503, a photosensitive drum 504, a transfer drum 505, a pre-fixing conveyor 507, and a fixing unit 508.

The rotating polygon mirror 503 modulates, for example, a light beam such as a laser beam according to the image data generated in the scanner 2070, and irradiates the photosensitive drum 504 with the modulated light beam. The light beam forms a latent image on the photosensitive drum 504. The latent image on the photosensitive drum 504 is developed by toner so that a toner image is formed. The toner image is transferred to a sheet material affixed onto the transfer drum 505. This series of steps in an image forming process is sequentially performed for toner of each of colors that are yellow (Y), magenta (M), cyan (C), and black (K), so that a full-color toner image is formed on the sheet material. After this image forming process is performed four times, a separation claw 506 separates the sheet material having the formed full-color toner image from the transfer drum 505. The pre-fixing conveyor 507 then conveys the separated sheet material to the fixing unit 508.

The fixing unit 508 has a built-in heat source such as a halogen heater. The fixing unit 508 dissolves and fixes the toner image transferred onto the sheet material by heat and pressure. A sheet discharge flapper 509 is capable of swinging around a swing shaft to define a conveyance direction of the sheet material. When the sheet discharge flapper 509 swings in a clockwise direction in FIG. 5, the sheet material is conveyed straight and then discharged to the outside of the printing apparatus 500 by a sheet discharge roller 510. In formation of an image on both sides of the sheet material, when the sheet discharge flapper 509 swings in a counterclockwise direction in FIG. 5, the sheet material is caused to change a direction to go downward, and then conveyed to a two-sided conveyance unit.

The two-sided conveyance unit includes a reversing flapper 511, reversing rollers 512, a reversing guide 513, and a two-sided tray 514. The reversing flapper 511 is capable of swinging around a swing shaft, and determines a conveyance direction of the sheet material. When executing a two-sided printing job, the control unit 2000 causes the reversing flapper 511 to swing in the counterclockwise direction in FIG. 5, thereby sending the sheet material with a printed first surface to the reversing guide 513 via the reversing roller 512. Then, the control unit 2000 temporarily stops the reversing rollers 512 in such a state that a rear end of the sheet material is held between the reversing rollers 512. The control unit 2000 then causes the reversing flapper 511 to swing in the clockwise direction in FIG. 5. The control unit 2000 also causes the reversing rollers 512 to rotate in the opposite direction. As a result, the sheet material is conveyed upon switching back, and then guided to the two-sided tray 514 in such a state that the rear end and a front end of the sheet material are transposed.

The two-sided tray 514 temporarily carries the sheet material. The sheet material is then sent by a sheet refeeding roller 515 to a pair of registration rollers 516 again. At this time, the sheet material is conveyed while a surface (a second surface), which is opposite to the first surface subjected to the image forming process, faces the photosensitive drum 504. Afterwards, an image is formed on the second surface of the sheet material in a manner similar to the above-described image forming process. After the images are thus formed on both sides of the sheet material, the sheet material undergoes a fixing process. The sheet material is then discharged from the inside to the outside of the printing apparatus 500 via the sheet discharge roller 510. The control unit 2000 executes such a series of steps in a two-sided printing sequence, thereby performing two-sided printing, in which image data of a job that is a target of the two-sided printing is formed on the first and second surfaces of the sheet material.

A sheet feeding unit containing the sheet materials includes sheet feeding cassettes 517 and 518, a paper deck 519, and a manual sheet feeding tray 520. A feed roller 521 and the pair of registration rollers 516 are each provided as a device for feeding the sheet materials contained in the sheet feeding unit to the transfer drum 505. Sheet materials of various sizes and various row materials are classified by type and held in the sheet feeding cassettes 517 and 518 as well as the paper deck 519.

The manual sheet feeding tray 520 can also hold various printed media including special sheet materials such as over head projector (OHP) sheets. The sheet feeding cassettes 517 and 518, the paper deck 519, and the manual sheet feeding tray 520 are each provided with the feed roller 521, and can successively feed the sheet materials one by one. For example, the stacked sheet materials are successively picked up by a pickup roller, and sent out one by one to a conveyance guide by a separation roller provided opposite to the feed roller 521. Here, a torque limiter (not illustrated) supplies the separation roller with a driving force for causing rotation in the direction opposite to a conveyance direction. When only one sheet material enters a nip part formed between the feed roller 521 and the separation roller, the feed roller 521 rotates in the conveyance direction by following the sheet material. When overlap feeding occurs, overlapping sheet materials are returned by the feed roller 521 rotating in the direction opposite to the conveyance direction, so that only the uppermost sheet is sent out.

The sent-out sheet material is guided in the conveyance guide, and conveyed to the pair of registration rollers 516 by a plurality of conveyance rollers. In this process, the pair of registration rollers 516 is at rest. When a tip of the sheet material abuts a nip part formed by the pair of registration rollers 516, the sheet material forms a loop so that skew is corrected. Subsequently, the pair of registration rollers 516 starts rotating to convey the sheet material, in appropriate timing for formation of the toner image on the photosensitive drum 504. The sheet material conveyed by the pair of registration rollers 516 is electrostatically attracted to a surface of the transfer drum 505 by an attraction roller 522. The sheet material is then discharged from the fixing unit 508 to a conveyance path for the sheet material in any one of the large capacity stacker 530, the glue binding apparatus 540, and the saddle stitch binding apparatus 560, via the sheet discharge roller 510.

Inside the printing apparatus 500, the conveyance path for the sheet material runs from a point where the sheet material is fed from the sheet feeding unit to a point where the sheet material is discharged from the sheet discharge roller 510. In this conveyance path, sheet detection sensors 580a to 580e are provided to detect a conveyance status and a jam of the sheet material. The control unit 2000 can find a location of occurrence of a sheet-material jam based on a result of detection by the sheet detection sensors 580a to 580e. The printing apparatus 500 has a cover (a door). A user can operate the inside of the printing apparatus 500 when the cover is in an open state. For example, when a sheet-material jam occurs in the conveyance path, the user opens the cover and performs an operation such as removal of a jammed sheet material. The printing apparatus 500 includes an open/close detection sensor provided to detect opening and closing of the cover. As to a cover, a plurality of covers may be provided along the conveyance path for the sheet material. In this case, the open/close detection sensor is to be provided to correspond to each of the covers.

The control unit 2000 executes a printing target job in the above-described printing process. The control unit 2000 causes the printer 2095 to execute print processing for the image data stored in the HDD 2004 based on a print execution request received from the user via the operation unit 2012.

The control unit 2000 stores in the HDD 2004 image data of a job to be processed sequentially from a top page, and forms an image of the image data on a sheet material by reading the image data sequentially from the top page. The control unit 2000 supplies the sheet materials having the image data printed sequentially from the top page, with an image side facing downward, to the conveyance path of any one of the large capacity stacker 530, the glue binding apparatus 540, and the saddle stitch binding apparatus 560. Therefore, the sheet discharge flapper 509 and the reversing roller 512 turn over the sheet material from the fixing unit 508, immediately before the sheet discharge roller 510 guides the sheet material to any one of the large capacity stacker 530, the glue binding apparatus 540, and the saddle stitch binding apparatus 560. The control unit 2000 also executes such paper handling control for processing the top page.

Configurations of the large capacity stacker 530, the glue binding apparatus 540, and the saddle stitch binding apparatus 560 will be described. In the configuration described in the present exemplary embodiment, three post-processing apparatuses, i.e., the large capacity stacker 530, the glue binding apparatus 540, and the saddle stitch binding apparatus 560 are connected to the printing apparatus 500. However, the number of the post-processing apparatuses is determined according to a usage environment or a necessary function. For example, a configuration having no post-processing apparatus may be adopted.

### <Large Capacity Stacker 530>

Operations of the large capacity stacker 530 are controlled by the control unit 2000. Inside the large capacity stacker 530, three conveyance paths, i.e., a straight path 531, an escape path 532, and a stack path 533 are provided as the conveyance paths for the sheet material from the printing apparatus 500.

On the straight path 531, a sheet detection sensor 580f is provided to detect a conveyance status and a jam of the sheet material. The control unit 2000 can find a location of occurrence of a sheet-material jam based on a result of detection by the sheet detection sensor 580f. The large capacity stacker 530 has a cover. A user can operate the inside of the large capacity stacker 530 when the cover is in an open state. For example, when a sheet-material jam occurs, the user opens the cover and performs an operation such as removal of a jammed sheet material. The large capacity stacker 530 includes an open/close detection sensor provided to detect opening and closing of the cover.

The straight path 531 is a conveyance path for the sheet material and is provided to supply the sheet material to the glue binding apparatus 540 in a subsequent stage without performing processing by the large capacity stacker 530. The escape path 532 is a conveyance path for the sheet material and is provided to output the sheet material from the large capacity stacker 530. For example, when the glue binding apparatus 540 in the subsequent stage is not connected, or when confirmation work (proof print) of an image formed on the sheet material is to be performed, the sheet material is conveyed to the escape path 532 to be picked up from the large capacity stacker 530. The stack path 533 is a conveyance path for the sheet material and is provided to convey the sheet material to a stack tray 534 serving as a stacking unit in the large capacity stacker 530. The sheet material conveyed to the stack tray 534 undergoes stacking processing.

The stack tray 534 is a stacking unit mounted on a stay 535 that can expand and contract. A coupling part between the stack tray 534 and the stay 535 has a shock absorber. The control unit 2000 performs the stacking processing of the printed sheet materials by using the stack tray 534. A carriage 536 is provided under the stay 535, so that the stacked sheet materials can be transported to another unit such as an offline finisher, when a handle (not illustrated) is attached.

When the cover of the large capacity stacker 530 is closed, the stack tray 534 ascends to a position that allows easy stacking of the sheet materials. When the cover (a front door) is opened (or an instruction for opening the cover is provided), the stack tray 534 descends. Stacking of the sheet materials on the stack tray 534 is either uniform stacking or shift stacking. In the uniform stacking, the sheet materials are laid at the same position on the stack tray 534. In the shift stacking, the sheet materials are laid on the stack tray 534 while being shifted by predetermined copy count or job in a back-to-front direction, so that the sheet materials are separated into bundles that can be handled easily. In this way, in the stacking processing of the sheet materials, several stacking ways can be performed. The control unit 2000 controls such various kinds of operations.

### <Glue Binding Apparatus 540>

Operations of the glue binding apparatus 540 are controlled by the control unit 2000. The glue binding apparatus 540 performs glue binding on the sheet materials supplied from the printing apparatus 500 via the large capacity stacker 530. The glue binding apparatus 540 includes a straight path 541, a book body path 542, and a cover path 543. The straight path 541 is a conveyance path for the sheet material and is provided to supply the sheet material to the saddle stitch binding apparatus 560 in a subsequent stage without performing glue binding processing by the glue binding apparatus 540. The book body path 542 and the cover path 543 are conveyance paths for the sheet material, and are each provided to perform case binding processing as the glue binding processing.

On the straight path 541, a sheet detection sensor 580g is provided to detect a conveyance status and a jam of the sheet material. The control unit 2000 can find a location of occurrence of a sheet-material jam based on a result of detection by the sheet detection sensor 580g. The glue binding apparatus 540 has a cover. A user can operate the inside of the glue binding apparatus 540 when the cover is in an open state. For example, when a sheet-material jam occurs in the conveyance path, the user opens the cover and performs an operation such as removal of a jammed sheet material. The glue binding apparatus 540 includes an open/close detection sensor provided to detect opening and closing of the cover.

In the case binding processing, the sheet materials printed in the printing apparatus 500 are bound to be one bundle of printed matter. In this way, the bundle of sheet materials having printed image data corresponding to a main part (contents) is formed in the case binding. The bundle will be referred to as “book body” in the present exemplary embodiment. In the case binding processing, the binding is performed by covering the book body with one sheet material for the cover. The sheet material for the cover is conveyed to a stack unit 544 via the cover path 543. The sheet materials to become the book body are successively conveyed to the stack unit 544 via the book body path 542, and then stacked. In the stack unit 544, the case binding processing is performed using the sheet materials to become the book body and the sheet material for the cover.

The sheet material for the cover to be used in the case binding is conveyed from an inserter tray 546 of an inserter 545 included in the glue binding apparatus 540. As the sheet material for the cover in the inserter tray 546, a pre-print sheet on which an image for the cover has been printed beforehand can be used. Alternatively, a sheet material on which an image for the cover has been printed by the printing apparatus 500 may be used.

In parallel with the conveyance of the sheet material for the cover, the glue binding apparatus 540 executes gluing processing for the sheet materials to become the book body that have been stacked in the stack unit 544. For example, a gluing unit 547 applies a predetermined amount of glue to a lower part of the sheet materials to become the book body. When the glue is sufficiently spread, the part applied with the glue is brought to abut on a central part of the sheet material for the cover, and the sheet materials to become the book body are covered with the sheet material for the cover, so that coupling is achieved. In the coupling, the sheet materials to become the book body are sent out by being pushed down. Therefore, the sheet materials to become the book body, which have been covered with the sheet material for the cover, slide down along a guide 548 to fall onto a turntable 549. The guide 548 then moves so that the sheet materials to become the book body, which have been covered with the sheet material for the cover, are laid on the turntable 549.

The glue binding apparatus 540 aligns the book body covered with the sheet material for the cover and laid on the turntable 549 by using an edge alignment unit 550. The glue binding apparatus 540 then performs cutting with a cutter 551, thereby forming a part to become a fore edge. Then, the glue binding apparatus 540 turns the turntable 549 by 90 degrees, and then upon performing alignment with the edge alignment unit 550, the glue binding apparatus 540 performs cutting thereby forming a part to become to a top edge. The glue binding apparatus 540 turns the turntable 549 further by 180 degrees, and then upon alignment with the edge alignment unit 550, the glue binding apparatus 540 performs cutting thereby forming a part to become to a bottom edge. After the cutting, the glue binding apparatus 540 places, in a basket unit 552, the completed book body covered with the sheet material for the cover by using the edge alignment unit 550. The glue is sufficiently dried in the basket unit 552, which completes the case binding.

### <Saddle Stitch Binding Apparatus 560>

Operations of the saddle stitch binding apparatus 560 are controlled by the control unit 2000. The saddle stitch binding apparatus 560 performs saddle stitching for the sheet materials supplied from the printing apparatus 500 via the large capacity stacker 530 and the glue binding apparatus 540. The saddle stitch binding apparatus 560 includes various units for selectively executing staple processing, cutting processing, punching processing, folding processing, and shift discharge processing on the sheet materials. No other devices are connected in a subsequent stage of the saddle stitch binding apparatus 560. Therefore, the saddle stitch binding apparatus 560 does not include a conveyance path for the sheet material for the subsequent stage.

On the conveyance path for the sheet material provided in the saddle stitch binding apparatus 560, a plurality of sheet detection sensors 580h and 580i is provided to detect a conveyance status and a jam of the sheet material. The control unit 2000 can find a location of occurrence of a sheet-material jam based on a result of detection by each of the sheet detection sensors 580h and 580i. The saddle stitch binding apparatus 560 has a cover. A user can operate the inside of the saddle stitch binding apparatus 560 when the cover is in an open state. For example, when a sheet-material jam occurs, the user opens the cover and performs an operation such as removal of a jammed sheet material. The saddle stitch binding apparatus 560 includes an open/close detection sensor provided to detect opening and closing of the cover.

The saddle stitch binding apparatus 560 includes a sample tray 561, a stack tray 562, and a booklet tray 563, as units. The control unit 2000 switches from one unit to another for use according to a job type or the number of sheet materials to be discharged.

For example, when receiving a staple processing execution request from the operation unit 2012, the control unit 2000 causes the saddle stitch binding apparatus 560 to convey the sheet materials from the printing apparatus 500 toward the stack tray 562. The sheet materials are successively stored in a processing tray 564 for each job. When the sheet materials are stored for one bundle, the sheet materials of this bundle are bound, and then stapled by a stapler 565. The bound sheet materials for one bundle are discharged to the stack tray 562.

A Z-folding unit 566 is provided to fold the sheet materials into a form of a letter Z, and a puncher unit 567 is provided to form a plurality of holes (to perform punching processing) on the sheet materials. The Z-folding unit 566 and the puncher unit 567 each perform processing according to a job type. For example, when Z-folding processing is set through the operation unit 2012, the Z-folding unit 566 performs the folding processing. After the folding processing, the sheet materials are discharged to a discharge tray such as the stack tray 562 and the sample tray 561. When punching processing is set through the operation unit 2012, the puncher unit 567 performs the punching processing. After the punching processing, the sheet materials are discharged to the discharge tray such as the stack tray 562 and the sample tray 561.

A saddle stitcher unit 568 performs saddle stitch binding processing for making a booklet such as a pamphlet. In the saddle stitch binding processing, the sheet materials are bound at two positions in a central part, and this central part is sandwiched between rollers so that the sheet materials are folded into two. The sheet materials bound by the saddle stitcher unit 568 are discharged to the booklet tray 563.

An inserter 569 has an inserter tray 570, and sends sheet materials set in the inserter tray 570 to the discharge tray that is either the stack tray 562 or the sample tray 561. Thus, the sheet materials set in the inserter 569 can be inserted into (placed into) the bundle of sheet materials supplied from the printing apparatus 500. The sheet materials are set in a face-up state in the inserter tray 570 of the inserter 569 by the user, and then successively conveyed by a pickup roller, starting from the uppermost sheet material. Therefore, the sheet materials from the inserter 569 are discharged directly to the stack tray 562 or the sample tray 561, in a face-down state. When being conveyed to the saddle stitcher unit 568, the sheet materials are temporarily sent toward the puncher unit 567, and then sent to the saddle stitcher unit 568 upon switching back, so that the sheet materials face in the same direction.

Further, the saddle stitch binding apparatus 560 includes a cutting unit (a trimmer unit 571). The sheet materials formed to be the booklet (a saddle-stitched booklet) in the saddle stitch binding apparatus 560 are supplied to the trimmer unit 571. The booklet is conveyed for only a predetermined length, and then cut by a cutter 572 to remove a part of the predetermined length. Ends of the respective sheet materials of the booklet are thus aligned. The booklet is then stored in a booklet holding unit 573.

The sheet detection sensors 580a to 580i for detecting a sheet-material jam are provided along the conveyance paths for the sheet material in the printing apparatus 500, the large capacity stacker 530, the glue binding apparatus 540, and the saddle stitch binding apparatus 560. The sheet detection sensors 580a to 580i may each be a sensor using a mechanical flag, or may be a sensor using an optical element. Each of the sheet detection sensors 580a to 580i illustrated in FIG. 5 is an application example, and is not limited in terms of arrangement position. For example, in a case of detecting all sheet materials remaining in the image forming system 200 at occurrence of a jam, it is desirable to arrange the sheet detection sensors 580a to 580i at regular intervals on the conveyance paths of the apparatuses.

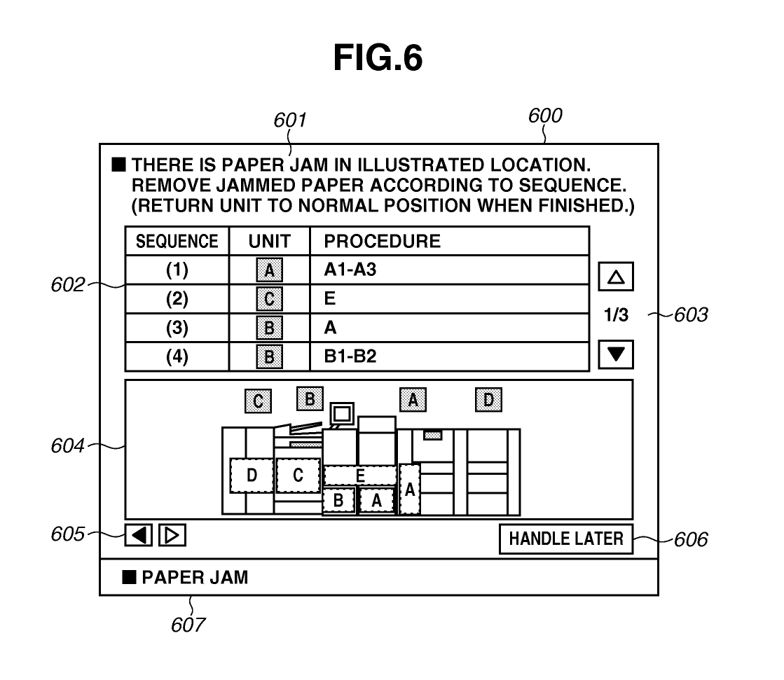

FIG. 6 is an example diagram of a dialog box for prompting a user to carry out jam clearing at occurrence of a sheet-material jam. When any of the sheet detection sensors 580a to 580i detects occurrence of a jam, the control unit 2000 displays a dialog box 600 on the display 2013.

In a message display region 601 of the dialog box 600, a message representing an instruction for jam clearing is displayed. A list display region 602 of the dialog box 600 includes “sequence”, “unit”, and “procedure” as items, and displays a list of jams. This list includes a jam clearing sequence, jam occurrence locations, and a jam clearing procedure. The item “sequence” indicates the jam clearing sequence, and the top of the list indicates a jam to be cleared first. The item “unit” indicates unit symbols of the respective apparatuses each having a jam. The unit symbols are associated with unit symbols in a device diagram displayed in a device diagram display region 604. The item “procedure” indicates the jam clearing procedure by using operation instruction symbols. Parts in each of the apparatuses are provided with respective operation instruction symbols that are associated with the respective operation instruction symbols listed in the item “procedure”.

When the list of jams displayed in the list display region 602 is not contained on one page, a “list forwarding” button 603 is operated by the user to switch the list to the next page or the previous page. The device diagram display region 604 displays the unit symbols and the operation instruction symbols corresponding to the locations where the jams have occurred. The operation instruction symbol corresponding to “1” of “sequence” in the list display region 602 blinks to guide the user to the location to be operated. When the device diagram displayed in the device diagram display region 604 is not contained in one screen, a left button or a right button of a “device diagram switching” button 605 is pressed by the user to display a hidden part of the apparatus by switching.

A “handle later” button 606 is to be pressed by the user to suspend jam clearing handling, so that the dialog box 600 can be closed. Upon closing the dialog box 600, the display 2013 returns to a screen displayed before displaying the dialog box 600. Therefore, an operation not affected by the jam can be continued in a state where the jam clearing is suspended. In addition, to display the dialog box 600 again, the user gives an instruction for redisplaying, on a screen such as a job status screen (not illustrated). A status line 607 is a region for displaying a message representing a currently occurring phenomenon. When two or more phenomena simultaneously occur, a message representing a highest priority phenomenon appears first, and the other phenomena are periodically switched to be displayed.

The list display region 602 and the device diagram display region 604 are updated, when the jam is cleared. In the list display region 602, the cleared jam is deleted from the list, and the remaining jams are displayed in order of priority. When the jam is cleared, the device diagram display region 604 disables display of the operation instruction symbol of the cleared jam, and blinks the operation instruction symbol to be operated next.

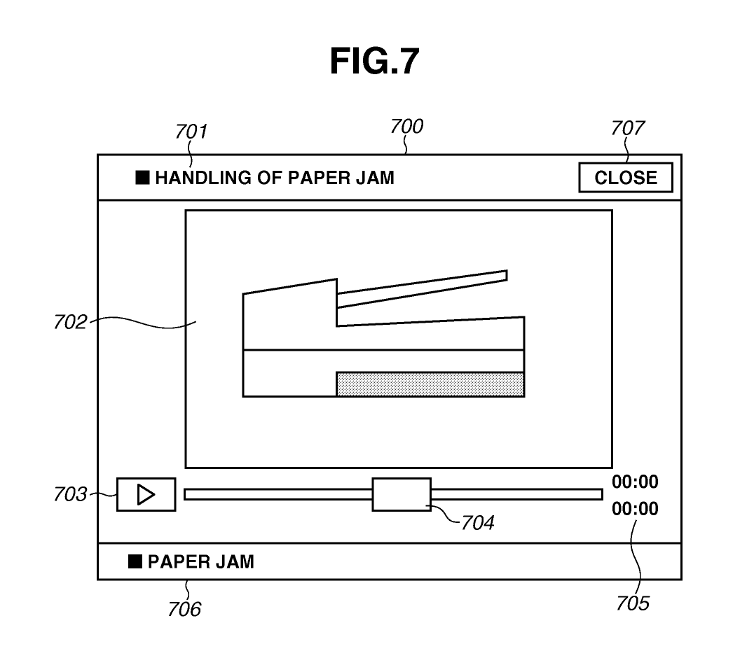

FIG. 7 is an example diagram of a moving image dialog box for prompting the user to carry out jam clearing by referring to a moving image at occurrence of a jam. A moving image dialog box 700 displays an advance preparation moving image or a main moving image that provides an instruction for jam clearing. The advance preparation moving image displays a process to be performed before executing a jam clearing procedure. The advance preparation moving image displays, for example, an instruction for opening a cover. The main moving image displays the jam clearing procedure.

When an arbitrary button is operated in a state where the dialog box 600 is displayed, the moving image dialog box 700 displays the advance preparation moving image. Here, the operation of an “arbitrary button” is such an event that the user selects the top of the list in the list display region 602 or operates a button for displaying the advance preparation moving image. The main moving image appears in the moving image dialog box 700, when the open/close detection sensor detects opening of the relevant cover in the state of the dialog box 600 being displayed or in the state of the advance preparation moving image being displayed.

A screen title 701 of the moving image dialog box 700 displays a title representing the instruction for the jam clearing. In a moving image display area 702, the advance preparation moving image or the main moving image appears. In addition, words for assisting the jam clearing procedure appear. The moving image is reproduced at a press of a moving image play/stop button 703 in a state of the moving image being stopped. The moving image stops at a press of the moving image play/stop button 703 in a state of the moving image being reproduced. A seek bar 704 indicates a reproducing position or the progress of the moving image. The seek bar 704 includes a laterally long bar-like part (hereinafter referred to as “bar”), and a knob-like operation part (hereinafter referred to as “slider”) displayed at the left end in the initial state. The reproducing position of the moving image can be moved by dragging the slider on the bar or pressing the bar. In a time display region 705, reproducing time appears in an upper part, and total reproducing time appears in a lower part. A status line 706 is a region for displaying a message representing a currently occurring phenomenon. When two or more phenomena simultaneously occur, a message representing a highest priority phenomenon appears first, and the other phenomena are periodically switched to be displayed.

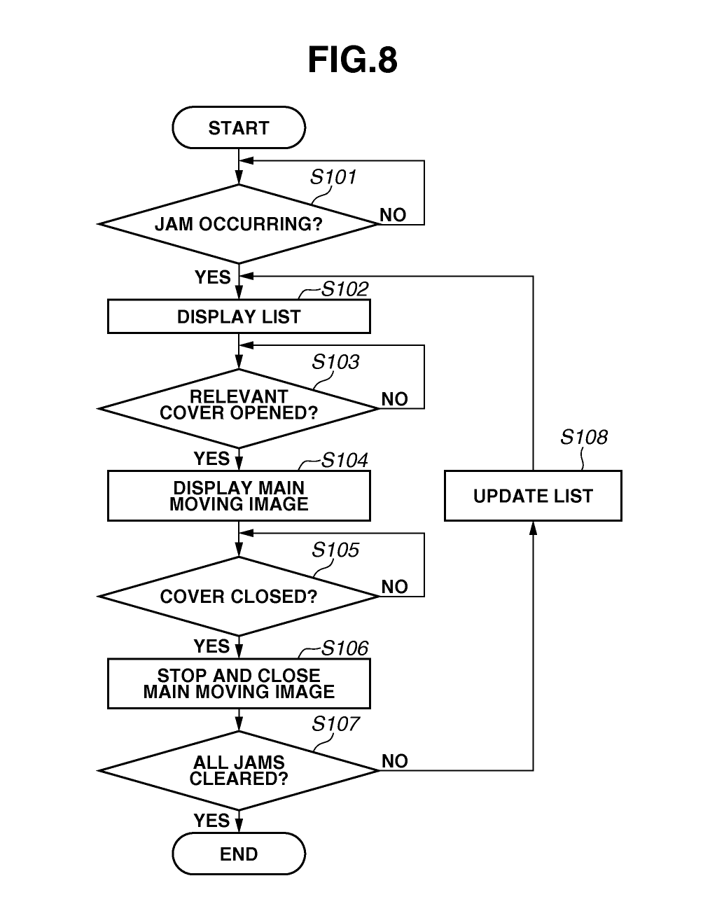

FIG. 8 is a flowchart illustrating a clearing procedure performed by the image forming system 200 at occurrence of a jam. Processing in this flowchart is performed when the CPU 2001 of the image forming system 200 executes a control program.

In step S101, occurrence of a jam is to be detected by any of the sheet detection sensors 580a to 580i in the image forming system 200. If occurrence of a jam is detected (Yes in step S101), then in step S102, the CPU 2001 displays the dialog box 600 on the display 2013. A list presenting a procedure for jam clearing is thus displayed.

In step S103, after the dialog box 600 is displayed, the CPU 2001 waits until a relevant cover is opened. The cover is presented at the top of the list displayed in the list display region 602 of the dialog box 600. Contents of the list in the list display region 602 are arranged in an order of a jam clearing procedure, and the user is instructed to carry out the jam clearing in this order. The cover is presented according to a jam occurrence location. For example, when a jam occurs in the printing apparatus 500, the user is instructed to open the cover of the printing apparatus 500 at the top of the list in the list display region 602.

In step S103, the CPU 2001 determines whether opening of the cover is detected by the open/close detection sensor in the image forming system 200. When a cover other than the relevant cover is opened (No in step S103), the CPU 2001 notifies the user of a fact that a cover other than the relevant cover is opened, and waits until the relevant cover is opened. The user is notified using, for example, a message or a pop-up displayed in the dialog box 600, or a beep.

If the relevant cover is opened (Yes in step S103), then in step S104, the CPU 2001 displays the moving image dialog box 700 on the display 2013. Here, the main moving image appears in the moving image dialog box 700. When a jam occurs at a location near the display 2013, the moving image is automatically reproduced because the user can handle the jam while viewing the display 2013. When a jam occurs at a location away from the display 2013, it is difficult for the user to handle the jam while viewing the display 2013 and therefore, the user may manually reproduce the moving image not to miss the procedure.

After clearing the jam by viewing the displayed main moving image, the user closes the cover. In step S105, the open/close detection sensor detects whether the cover is closed. If closing of the cover is detected by the open/close detection sensor (Yes in step S105), then in step S106, the CPU 2001 stops the main moving image and closes the moving image dialog box 700. Then, in step S107, the CPU 2001 determines whether all the detected jams are cleared.

When all the jams are cleared (Yes in step S107), the CPU 2001 ends the processing. If a jam yet to be cleared remains (No in step S107), then in step S108, the CPU 2001 updates the dialog box 600 and displays the next processing at the top of the list. The list is updated in response to acquisition of the jam occurrence location performed again by the sheet detection sensors 580a to 580i. According to the jam occurrence location acquired again, the jam occurrence location of the next highest priority is displayed at the top of the list. The processing from step S101 to step S107 is performed until it is determined that all the jams are cleared.

As described above, the jams are cleared in order of priority. The main moving image is reproduced when the cover is in the open state. Therefore, it is not necessary to display the advance preparation moving image that provides an instruction for opening the cover corresponding to the jam occurrence location. Moreover, the user can perform appropriate maintenance by viewing the main moving image.

In a present second exemplary embodiment, jam clearing is performed by processing different from that of the above-described first exemplary embodiment, in an image forming system 200 configured in a manner similar to that of the first exemplary embodiment. A configuration of this image forming system 200 will not be repeatedly described.

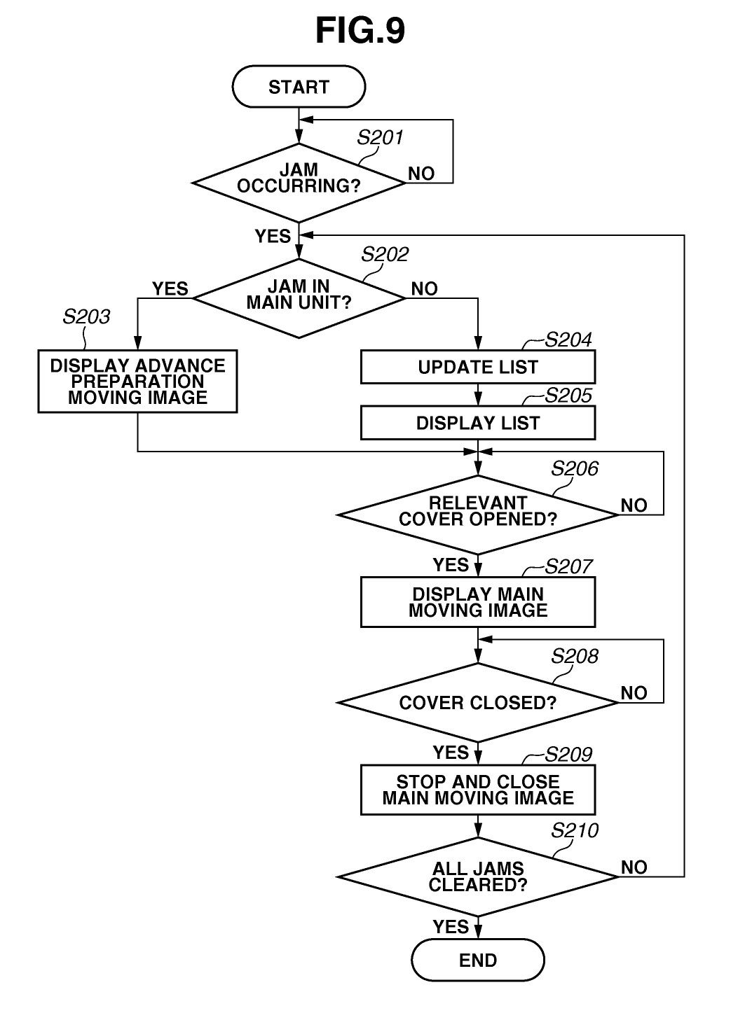

FIG. 9 is a flowchart illustrating a clearing procedure performed by the image forming system 200 at occurrence of a jam according to the second exemplary embodiment. A CPU 2001 of the image forming system 200 performs the processing by executing a control program.

If occurrence of a jam is detected by any of sheet detection sensors 580a to 580i in the image forming system 200 (Yes in step S201), then in step S202, the CPU 2001 determines whether a jam occurrence location is in a main unit (apparatus) of the image forming system 200. Here, the “main unit” refers to the printing apparatus 500, but may be a configuration in which other sheet processing apparatuses are added to the printing apparatus 500.

If the jam occurrence location is in the main unit (Yes in step S202), then in step S203, the CPU 2001 displays a moving image dialog box 700 on a display 2013. Here, an advance preparation moving image appears in the moving image dialog box 700. When the jam occurrence location is not in the main unit (No in step S202), then in steps S204 and S205, the CPU 2001 displays a dialog box 600 on the display 2013. A list presenting a procedure for jam clearing is thus displayed.

Subsequent processing in step S206 to step S210 is similar to the processing in step S103 to step S107 of the first exemplary embodiment and therefore will not be described. When all the detected jams are cleared (Yes in step S210), the CPU 2001 ends the processing.

As described above, the jams are cleared in order of priority. In the second exemplary embodiment, the main unit and other apparatuses are distinguished from each other, and the advance preparation moving image is displayed when a jam occurs in the main unit. The printing apparatus 500 serving as the main unit typically includes a plurality of covers, and a cover to be opened is distinct according to the jam occurrence location. Therefore, at occurrence of a jam in the printing apparatus 500, a user is notified of which cover is to be opened in the advance preparation moving image. In addition, when an apparatus having a plurality of covers is provided, the “main unit” may include the apparatuses other than the printing apparatus 500. In other words, one or more apparatuses may be provided as the “main unit”.

In a present third exemplary embodiment, jam clearing is performed by processing different from that of the above-described first exemplary embodiment, in an image forming system 200 configured in a manner similar to that of the first exemplary embodiment. A configuration of this image forming system 200 will not be described.

In the first and second exemplary embodiments, the main moving image is displayed when the relevant cover is opened in a state of the dialog box 600 being displayed. However, there may be a user who does not understand how to operate, and cannot reach the display of the main moving image by merely viewing the dialog box 600. In the third exemplary embodiment, an advance preparation moving image can be displayed before a main moving image. Therefore, the main moving image is appropriately displayed so that even a user inexperienced in an operation can perform jam clearing.

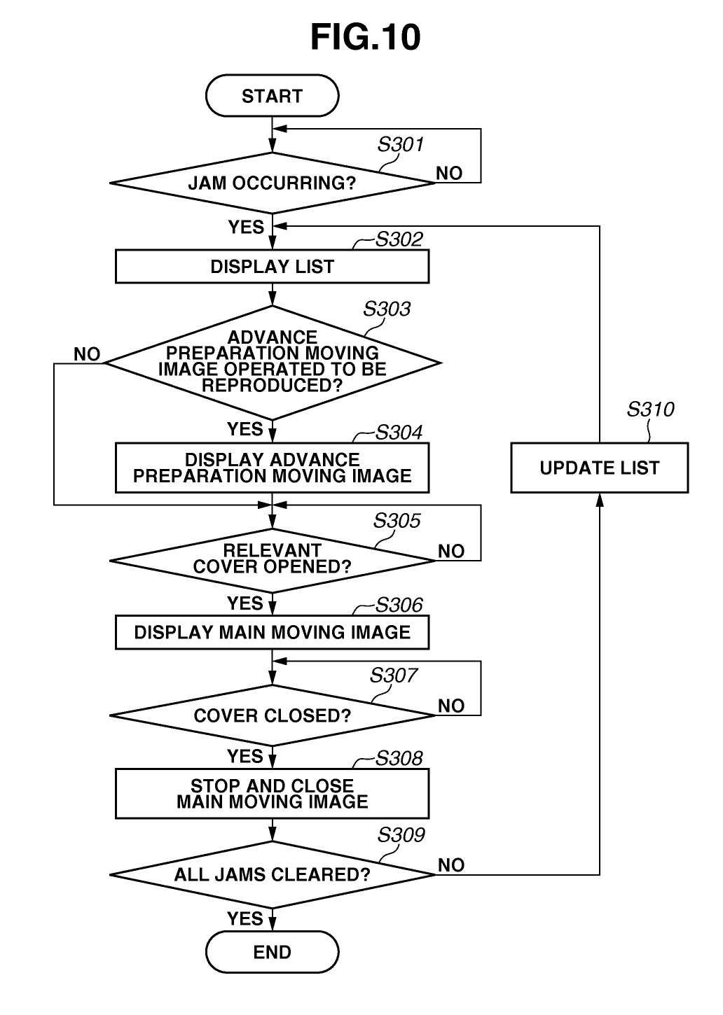

FIG. 10 is a flowchart illustrating a clearing procedure performed by the image forming system 200 at occurrence of a jam, according to the third exemplary embodiment. A CPU 2001 of the image forming system 200 performs the processing by executing a control program.

If occurrence of a jam is detected by any of sheet detection sensors 580a to 580i in the image forming system 200 (Yes in step S301), then in step S302, the CPU 2001 displays a dialog box 600 on a display 2013. A list presenting a procedure for jam clearing is thus displayed.

In step S303, the CPU 2001 determines whether an operation for reproducing the advance preparation moving image is performed in the dialog box 600. The operation for reproducing the advance preparation moving image is performed, for example, by selecting the top of the list in the list display region 602 of the dialog box 600. In addition, a button for reproducing the advance preparation moving image may be provided in the dialog box 600.

If the operation for reproducing the advance preparation moving image is performed (Yes in step S303), then, in step S304, the CPU 2001 displays the advance preparation moving image on the display 2013. When the operation for reproducing the advance preparation moving image is not performed (No in step S303), or after the advance preparation moving image has been displayed, the CPU 2001 performs processing in step S305 to step S309 similar to the processing in step S103 to step S107 in the first exemplary embodiment. The processing in step S305 to step S309 will not be described. When all the detected jams are cleared (Yes in step S309), the CPU 2001 ends the processing.

In the first, second, and third exemplary embodiments, the maintenance performed by the combination of the list and the moving image has been described. However, a list-only mode, a moving-image-only mode, and a list-and-moving-image combination mode may be provided, and the maintenance may be performed by switching from one mode to another. For example, a switch for enabling advance setting of the mode may be provided at a location where device settings can be performed by a press of the user mode key 406 (see FIG. 4). Further, a mode-switching button may be provided in the dialog box 600 or the moving image dialog box 700. Thus, it is possible to provide an easy-to-perform operation instruction suitable for needs of the user.

According to each of the above-described exemplary embodiments, a moving image presenting a procedure for clearing a jam is displayed when a cover of an apparatus where the jam has occurred is in an open state, so that even a user inexperienced in an operation can perform appropriate maintenance.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-260410 filed Dec. 17, 2013, which is hereby incorporated by reference herein in its entirety.

What is claimed is:

1. An image forming system comprising:
a plurality of sheet detection sensors provided along a conveyance path for a sheet material conveyed in a plurality of apparatuses, and configured to detect a jam of the sheet material;
a plurality of covers provided in each of the plurality of apparatuses, and each configured to allow an operation by a user in the apparatus when being in an open state;
a plurality of open/close detection sensors provided to correspond to each of the plurality of covers, and each configured to detect opening and closing of the corresponding cover; and
a control unit configured to display, when the jam has been detected, occurrence of the jam together with the apparatus including the sheet detection sensor that has detected the jam, and to display, when the open/close detection sensor corresponding to the cover of the apparatus detects the open state of the cover, a moving image presenting a procedure for clearing the jam on a predetermined display.

2. The image forming system according to claim 1, wherein when a plurality of jams has been detected, the control unit displays the apparatuses including the sheet detection sensors that have detected the respective jams in order of clearing the jams, and displays, when the cover of the apparatus including the sheet detection sensor that has detected the jam to be cleared first is in the open state, a moving image presenting a procedure for clearing the jam on the display.

3. The image forming system according to claim 2, wherein the control unit displays, on the display, a list in which the apparatuses including the sheet detection sensors that have detected the respective jams are arranged in order of clearing the jams, and updates the list when clearing one of the jams is completed.

4. The image forming system according to claim 1, wherein the plurality of apparatuses each includes a plurality of covers, and
wherein, when the jam has been detected in the apparatus including the plurality of covers, the control unit displays, on the display, an advance preparation moving image presenting which of the covers of the apparatus is to be in an open state.

5. The image forming system according to claim 1, wherein, when the jam has been detected, the control unit displays, in displaying the occurrence of the jam together with the apparatus including the sheet detection sensor that has detected the jam, a button provided to instruct display of an advance preparation moving image presenting which of the covers is to be in an open state.

6. A jam clearing method executed in a system including a plurality of sheet detection sensors provided along a conveyance path for a sheet material conveyed in a plurality of apparatuses, and configured to detect a jam of the sheet material, a plurality of covers provided in each of the plurality of apparatuses, and each configured to allow an operation by a user in the apparatus when being in an open state, and a plurality of open/close detection sensors provided to correspond to each of the plurality of covers, and each configured to detect opening and closing of the corresponding cover,
the method comprising:
displaying, when the jam has been detected, occurrence of the jam together with the apparatus including the sheet detection sensor that has detected the jam, and displaying, when the open/close detection sensor corresponding to the cover of the apparatus detects the open state of the cover, a moving image presenting a procedure for clearing the jam on a predetermined display.

7. A storage medium storing a computer program for a computer including a plurality of sheet detection sensors provided along a conveyance path for a sheet material conveyed in a plurality of apparatuses, and configured to detect a jam of the sheet material, a plurality of covers provided in each of the plurality of apparatuses, and each configured to allow an operation by a user in the apparatus when being in an open state, and a plurality of open/close detection sensors provided to correspond to each of the plurality of covers, and each configured to detect opening and closing of the corresponding cover,
the computer program causing the computer to perform: displaying, when the jam has been detected, occurrence of the jam together with the apparatus including the sheet detection sensor that has detected the jam, and displaying, when the open/close detection sensor corresponding to the cover of the apparatus detects the open state of the cover, a moving image presenting a procedure for clearing the jam on a predetermined display.
